(19) United States
(12) Patent Application Publication
(10) Pub. No.: US 2026/0153814 A1
(43) Pub. Date: Jun. 4, 2026

(54) IMAGE FORMING APPARATUS

(71) Applicant: KYOCERA Document Solutions Inc., Osaka (JP)

(72) Inventors: Teruhiko NAGASHIMA, Osaka (JP); Kei WAKAYAMA, Osaka (JP)

(73) Assignee: KYOCERA Document Solutions Inc., Osaka (JP)

(21) Appl. No.: 19/394,359

(22) Filed: Nov. 19, 2025

(30) Foreign Application Priority Data
Dec. 4, 2024 (JP) 2024-210905

(51) Int. Cl. G03G 15/08

(52) U.S. Cl. CPC G03G 15/0872; G03G 15/0886; G03G 15/0889; G03G 15/0891

(57) ABSTRACT

An image forming apparatus includes an apparatus body, an image carrying member, a developing portion, and a container. The developing portion is supported to be swingable about a rotation shaft relative to the apparatus body, and is movable about the rotation shaft between a developing position where the developer carrying member is located close to the image carrying member and a retracted position where the developer carrying member is located away from the image carrying member. The container removably mounted in the apparatus body, and stores toner supplied to the developing portion. The rotation shaft of the developing portion has a toner inlet portion through which the toner in the container passes into the developing portion.

### INCORPORATION BY REFERENCE

This application is based on and claims the benefit of priority from Japanese Patent Application No. 2024-210905 filed on December 4, 2024, the contents of which are hereby incorporated by reference.

### BACKGROUND

The present disclosure relates to image forming apparatuses.

In image forming apparatuses such as copiers and printers, for stable developing performance during the development (formation) of a toner image, the outer circumferential surfaces of a photosensitive drum (image carrying member) and a development roller (developer carrying member) need to be held at a predetermined interval from each other or kept in contact with each other under a predetermined pressure. For that purpose, a configuration is often employed in which a developing portion is supported so as to be rotatable about a rotation shaft and is pressed toward the photosensitive drum such that the development roller can move closer to and away from the photosensitive drum.

### SUMMARY

According to one aspect of the present disclosure, an image forming apparatus includes an apparatus body, an image carrying member, a developing portion, and a container. On the outer circumferential surface of the image carrying member, an electrostatic latent image is formed. The developing portion has a developer carrying member that supplies toner to the electrostatic latent image to form a toner image. The developing portion is supported so as to be swingable about a rotation shaft relative to the apparatus body, and is movable about the rotation shaft between a developing position where the developer carrying member is located close to the image carrying member and a retracted position where the developer carrying member is located away from the image carrying member. The container is removably mounted in the apparatus body, and stores the toner supplied to the developing portion. The rotation shaft of the developing portion has a toner inlet portion through which the toner in the container passes into the developing portion.

### BRIEF DESCRIPTION OF THE DRAWINGS

FIG. 1 is an exterior perspective view of an image forming apparatus according to one embodiment of the present disclosure.

FIG. 2 is a schematic side sectional view of the image forming apparatus in FIG. 1.

FIG. 3 is a schematic side sectional view of an image forming portion in the image forming apparatus in FIG. 2.

FIG. 4 is a perspective view of an apparatus body of the image forming apparatus in FIG. 1, showing a state with exterior members removed.

FIG. 5 is a perspective view of the apparatus body in FIG. 4, showing a state with a developing portion removed.

FIG. 6 is an enlarged perspective part view around a rotation shaft in the developing portion in the apparatus body in FIG. 4.

FIG. 7 is an enlarged perspective part view around a bearing portion in the developing portion in the apparatus body in FIG. 4.

FIG. 8 is a perspective view of the developing portion in FIG. 4 as seen from the rotation shaft side.

FIG. 9 is a perspective view of the developing portion in FIG. 4 as seen from the bearing portion side.

FIG. 10 is an exterior perspective view of the image forming apparatus in FIG. 1, showing a state with a cover open and a toner container removed.

FIG. 11 is a perspective view of the toner container in FIG. 10.

FIG. 12 is a front sectional view of a coupling structure between the developing portion in FIG. 4 and the container.

FIG. 13 is a perspective view around a part of the developing portion in FIG. 8 around the rotation shaft.

FIG. 14 is a perspective view around a part of the developing portion in FIG. 13 around the rotation shaft, showing a state with a shutter member open.

FIG. 15 is an enlarged perspective part view of a part of the container in FIG. 11 around a toner outlet port.

### DETAILED DESCRIPTION

An embodiment of the present disclosure will be described below with reference to the accompanying drawings. It should be noted that what is disclosed below is not meant to limit the present disclosure in any way.

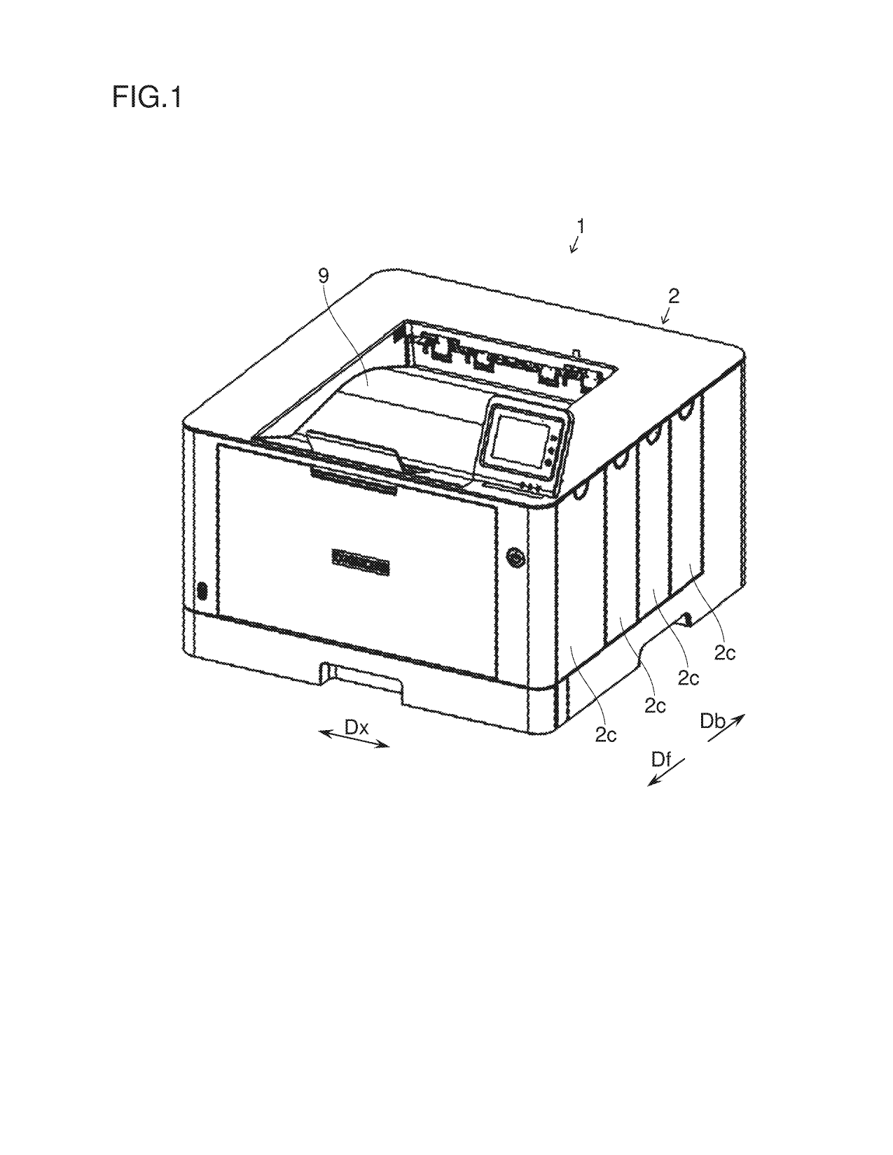

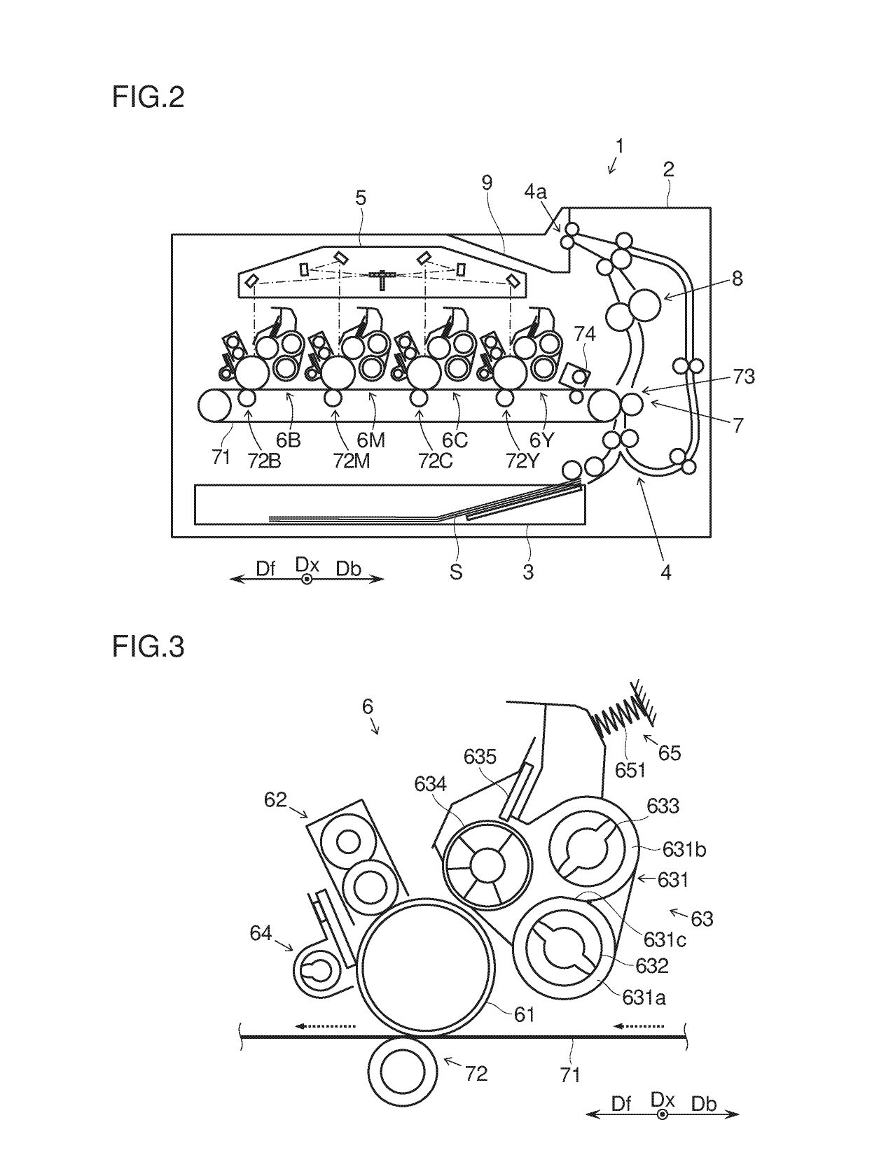

FIG. 1 is an exterior perspective view of an image forming apparatus 1 according to the embodiment. FIG. 2 is a schematic side sectional view of the image forming apparatus 1 in FIG. 1. FIG. 3 is a schematic side sectional view of an image forming portion 6 in the image forming apparatus 1 in FIG. 2. One example of the image forming apparatus 1 according to the embodiment is a tandem-type color printer that receives image data and a print command for a print job from an external computer and that transfers a toner image to a sheet S using an intermediate transfer belt 71. The image forming apparatus 1 can be what is called a multifunction peripheral provided with the functions of, for example, printing, scanning (image reading), facsimile transmission, and the like.

In the accompanying drawings, arrowed line Df indicates the front side (fore side) of the image forming apparatus 1 and arrowed line Db indicates the rear side (hind side) of the image forming apparatus 1. Arrowed line Dx indicates the lateral, left-right, direction of the image forming apparatus 1, which is the direction along which extend the rotation axes of roller-form members including a photosensitive drum 61 and a development roller 634, which will be described later; that is, this direction is the rotation axis direction.

As shown in FIGS. 1 and 2, the image forming apparatus 1 includes, in an apparatus body 2, a sheet feeding portion 3, a sheet conveying portion 4, an exposure portion 5, an image forming portion 6, a transfer portion 7, a fixing portion 8, a sheet discharge portion 9, and a control portion 10.

The sheet feeding portion 3 is disposed in a bottom part of the apparatus body 2. The sheet feeding portion 3 stores a plurality of unprinted sheets (recording medium) S and separates and feeds out one sheet after another during printing. The sheet conveying portion 4 extends along the top-bottom direction along a side wall of the apparatus body 2. The sheet conveying portion 4 conveys the sheet S fed out from the sheet feeding portion 3 to a secondary transfer portion 73 and then to the fixing portion 8, and then discharges the sheet S having undergone fixing to the sheet discharge portion 9 through a sheet discharge port 4a.

The exposure portion 5 is disposed in an upper part of the apparatus body 2. The exposure portion 5 irradiates the image forming portion 6 with laser light controlled based on image data.

The image forming portion 6 is disposed below the exposure portion 5, above an intermediate transfer belt 71. The image forming portion 6 includes an image forming portion 6Y for yellow, an image forming portion 6C for cyan, an image forming portion 6M for magenta, and an image forming portion 6B for black. These four image forming portions 6 have basically the same configuration; accordingly, in the following description, unless distinction is needed, the suffixes “Y,” “C,” “M,” and “B” indicating the colors are often omitted.

The image forming portion 6 includes a photosensitive drum (image carrying member) 61 that is supported so as to be rotatable in a predetermined direction (clockwise in FIGS. 2 and 3). The image forming portion 6 further includes, disposed around the photosensitive drum 61 along its rotation direction, a charging portion 62, a developing portion 63, and a drum cleaning portion 64. Between the developing portion 63 and the drum cleaning portion 64, a primary transfer portion 72 is disposed.

The photosensitive drum 61 is formed in a cylindrical shape extending along a horizontal direction and has a photosensitive layer formed on its outer circumferential surface. The charging portion 62 electrostatically charges the surface (outer circumferential surface) of the photosensitive drum 61 to a predetermined surface potential. The exposure portion 5 exposes to light the outer circumferential surface of the photosensitive drum 61 electrostatically charged by the charging portion 62 and forms, with attenuated electrostatic charge, an electrostatic latent image of a document image on the outer circumferential surface of the photosensitive drum 61. The developing portion 63 supplies toner to the electrostatic latent image on the outer circumferential surface of the photosensitive drum 61 to develop it to form a toner image. The four image forming portions 6 form toner images of different colors respectively. The drum cleaning portion 64 removes and collects deposits such as toner that are left on the outer circumferential surface of the photosensitive drum 61 after the primary transfer of the toner images to the outer circumferential surface of the intermediate transfer belt 71. In this way, the image forming portion 6 forms an image (toner image) to be later transferred to the sheet S.

The transfer portion 7 includes an intermediate transfer belt 71, primary transfer portions 72Y, 72C, 72M, and 72B, a secondary transfer portion 73, and a belt cleaning portion 74. The intermediate transfer belt 71 is disposed below the four image forming portions 6, above the sheet feeding portion 3. The intermediate transfer belt 71 is an endless intermediate transfer member that is supported so as to be rotatable in a predetermined direction (counter-clockwise in FIG. 2) and to which the toner images formed on the outer circumferential surfaces of the photosensitive drums 61 in the image forming portions 6 are primarily transferred sequentially so as to be overlaid on each other. The four image forming portions 6 are disposed in a row from upstream to downstream in the rotation direction of the intermediate transfer belt 71, in what is called a tandem arrangement.

The primary transfer portions 72Y, 72C, 72M, and 72B are disposed below the image forming portions 6Y, 6C, 6M, and 6B across the intermediate transfer belt 71. The secondary transfer portion 73 is disposed upstream of the fixing portion 8 with respect to the sheet conveyance direction of the sheet conveying portion 4, downstream of the image forming portions 6Y, 6C, 6M, and 6B with respect to the rotation direction of the intermediate transfer belt 71. The belt cleaning portion 74 is disposed downstream of the secondary transfer portion 73 with respect to the rotation direction of the intermediate transfer belt 71.

The primary transfer portion 72 transfers the toner image formed on the outer circumferential surface of the photosensitive drum 61 to the outer circumferential surface of the intermediate transfer belt 71. In other words, in the primary transfer portions 72Y, 72C, 72M, and 72B for the different colors, the toner images are primarily transferred to the outer circumferential surface of the intermediate transfer belt 71. Then, as the intermediate transfer belt 71 rotates, with predetermined timing, the toner images in the four image forming portions 6 are transferred sequentially, so as to be overlaid on each other, to the intermediate transfer belt 71, so that a color toner image having toner images of four colors, namely yellow, cyan, magenta, and black, overlaid on each other is formed on the outer circumferential surface of the intermediate transfer belt 71.

The color toner image on the outer circumferential surface of the intermediate transfer belt 71 is transferred to a sheet S conveyed in synchronization by the sheet conveying portion 4 in a secondary transfer nip portion formed in the secondary transfer portion 73. The belt cleaning portion 74 cleans the outer circumferential surface of the intermediate transfer belt 71 by removing deposits such as toner that are left there. In this way, the transfer portion 7 transfers (records) the toner image formed on the outer circumferential surface of the photosensitive drum 61 to the sheet S.

The fixing portion 8 is disposed above the secondary transfer portion 73. The fixing portion 8 heats and presses the sheet S having the toner image transferred to it to fix the toner image to the sheet S.

The sheet discharge portion 9 is disposed above the transfer portion 7. The sheet S having the toner image fixed to it and having completed printing is conveyed to the sheet discharge portion 9. The sheet discharge portion 9 permits the printed sheet (print result) to be taken out from above.

The control portion 10 includes a CPU, an image processor, a storage, and other electronic circuits and components (none is shown). Based on control programs and data stored in the storage, the CPU controls the operation of different parts of the image forming apparatus 1 to perform processes to carry out the functions of the image forming apparatus 1. The sheet feeding portion 3, the sheet conveying portion 4, the exposure portion 5, the image forming portion 6, the transfer portion 7, and the fixing portion 8 individually receive instructions from the control portion 10 and cooperate to perform printing on the sheet S. The storage is configured as, for example, a combination of a nonvolatile storage device such as a program ROM (read-only memory) and a data ROM and a volatile storage device such as a RAM (random-access memory).

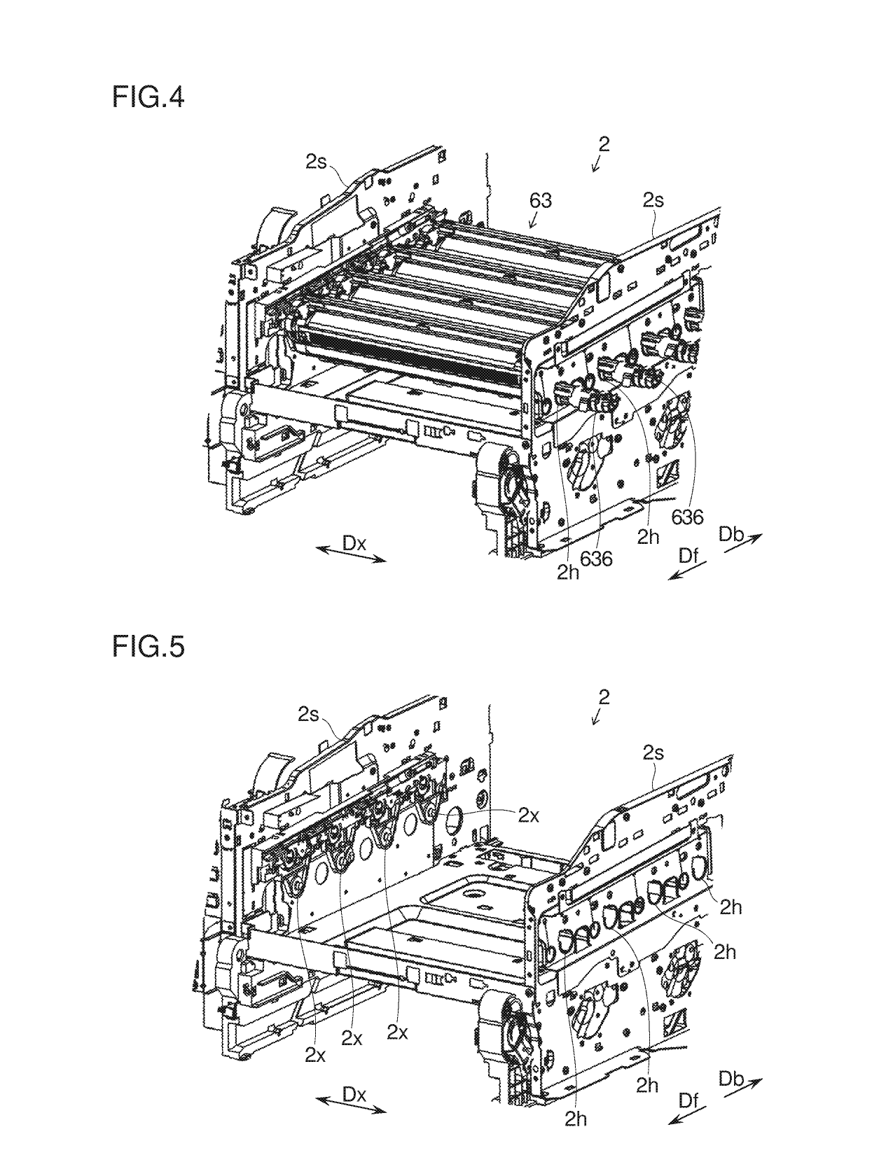

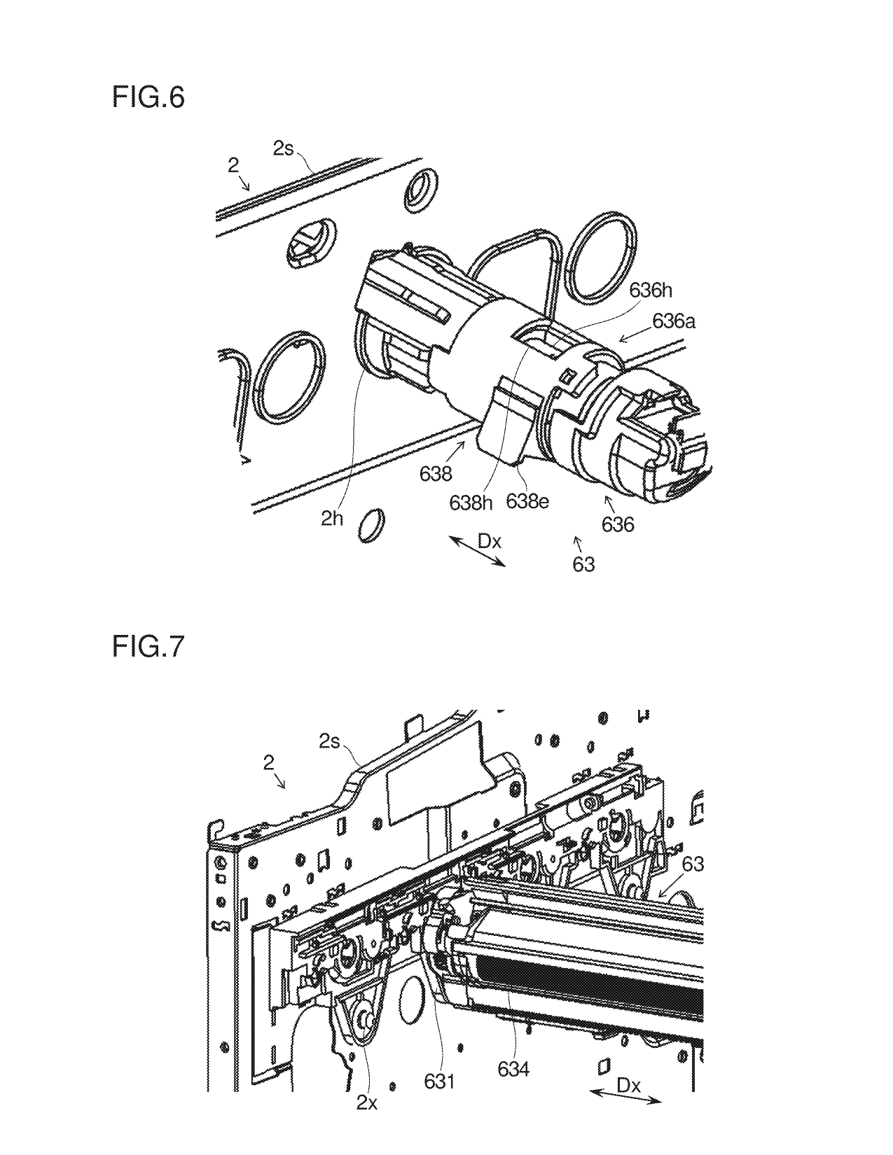

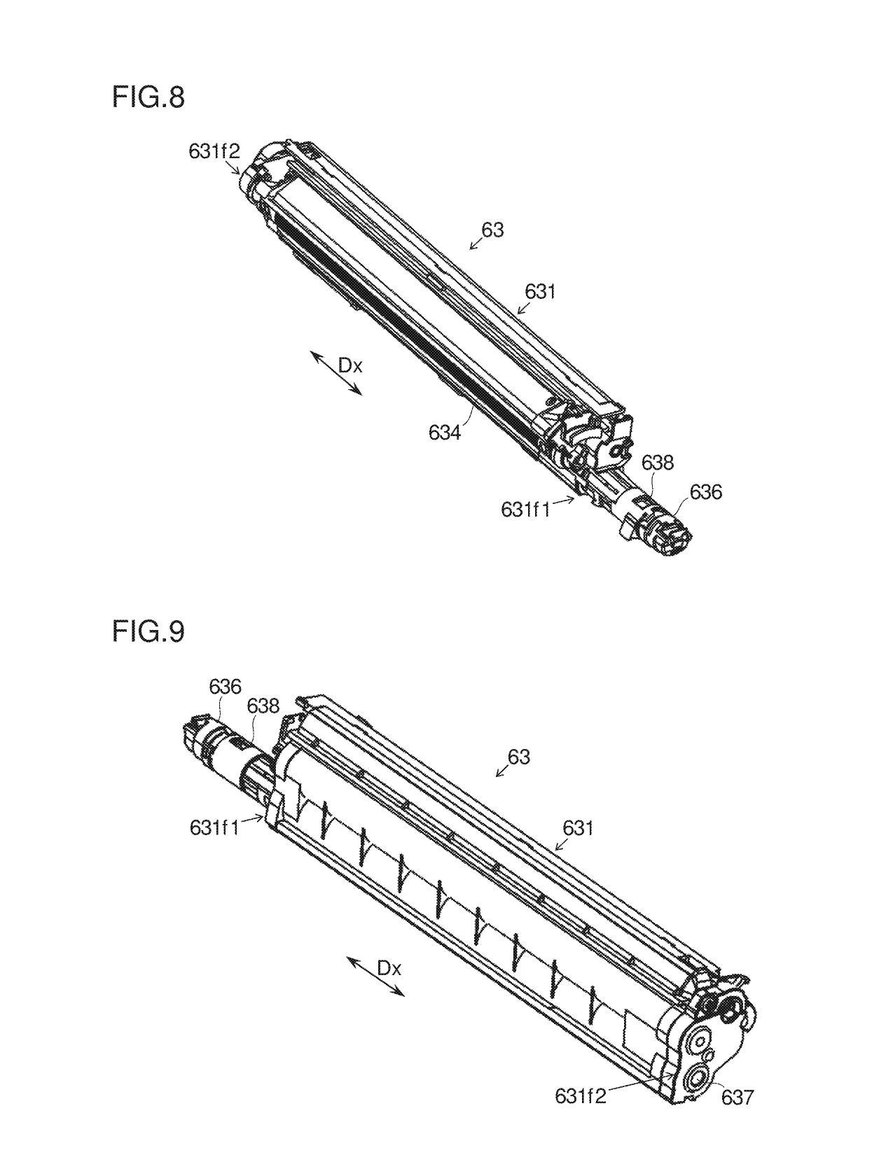

Next, the configuration around the image forming portion 6 will be described with reference to FIGS. 1, 2, and 3 and also to FIGS. 4 to 9. FIG. 4 is a perspective view of the apparatus body 2 of the image forming apparatus 1 in FIG. 1, showing a state with exterior members removed. FIG. 5 is a perspective view of the apparatus body 2 in FIG. 4, showing a state with the developing portion 63 removed. FIGS. 6 and 7 are enlarged perspective part views around a rotation shaft 636 and around a bearing portion 637, respectively of the developing portion 63 in the apparatus body 2 in FIG. 4. FIGS. 8 and 9 are perspective views of the developing portion 63 in FIG. 4 as seen from the rotation shaft 636 side and from the bearing portion 637 side, respectively. Note that FIGS. 4 to 7 show only those parts which are necessary to describe the embodiment and omit illustration of other general parts.

As shown in FIGS. 4 and 5, the apparatus body 2 has a pair of side plates 2s that are located at left and right, respectively, as seen from in front Df. The left-right pair of side plates 2s each extend along the front-rear and top-bottom directions. The photosensitive drum 61, the charging portion 62, the developing portion 63, and the drum cleaning portion 64 (for all these, see FIG. 3) of each of the four image forming portions 6 are supported between the left-right pair of side plates 2s.

As shown in FIG. 3, the developing portion 63 includes a developer container 631, a first conveying member 632, a second conveying member 633, a development roller (developer carrying member) 634, a regulating blade 635, a rotation shaft 636, and a bearing portion 637.

The developer container 631 has an elongate shape extending along the axial direction Dx of the photosensitive drum 61, and is disposed with its longitudinal direction horizontally aligned. That is, the longitudinal direction of the developer container 631 is parallel to the axial direction Dx of the photosensitive drum 61. The developer container 631 stores, for example, two-component developer containing toner and magnetic carrier as developer containing toner that is supplied to the photosensitive drum 61.

The developer container 631 has a first conveyance chamber 631a, a second conveyance chamber 631b, a partition portion 631c, and a pair of communication portions (not shown).

The first and second conveyance chambers 631a and 631b are provided inside the developer container 631. The first and second conveyance chambers 631a and 631b are disposed one above the other along the top-bottom direction. The first and second conveyance chambers 631a and 631b are formed as a result of the interior of the developer container 631 being divided by the partition portion 631c.

The partition portion 631c is provided inside the developer container 631, between the first and second conveyance chambers 631a and 631b. The partition portion 631c is formed substantially in the shape of a plate extending along the longitudinal direction of the developer container 631. The partition portion 631c divide the interior of the developer container 631 along a direction (the top-bottom direction in FIG. 3) crossing the longitudinal direction.

The second conveyance chamber 631b includes a space inside the developer container 631 around a region where the development roller 634 is disposed, and is disposed adjacent to the photosensitive drum 61. The first conveyance chamber 631a is disposed in a region inside the developer container 631 farther away from the photosensitive drum 61 than the second conveyance chamber 631b. The first conveyance chamber 631a is adjacent to a toner inlet portion, which will be described later and, through this toner inlet portion, developer is supplied into the developer container 631. In the first conveyance chamber 631a, the first conveying member 632 conveys developer from one side along the longitudinal direction of the developer container 631 to the other side (e.g., from the far side to the near side with respect to the plane of FIG. 3). In the second conveyance chamber 631b, the second conveying member 633 conveys developer from the other side along the longitudinal direction of the developer container 631 to one side (e.g., from the near side to the far side with respect to the plane of FIG. 3).

The pair of communication portions are disposed outward of opposite end parts, respectively, of the partition portion 631c along the longitudinal direction. Through the communication portions, the first and second conveyance chambers 631a and 631b communicate with each other along a direction (the top-bottom direction in FIG. 3) crossing the longitudinal direction of the partition portion 631c, that is, along the thickness direction of the partition portion 631c substantially in the shape of a plate. Through the pair of communication portions, the first and second conveyance chambers 631a and 631b communicate with each other in opposite end parts of the first and second conveyance chambers 631a and 631b along the longitudinal direction. Through the downstream-end communication portion along the developer conveyance direction in the first conveyance chamber 631a, developer is conveyed from the first conveyance chamber 631a to the second conveyance chamber 631b. Through the downstream-end communication portion along the developer conveyance direction in the second conveyance chamber 631b, developer is conveyed from the second conveyance chamber 631b to the first conveyance chamber 631a.

The first conveying member 632 is disposed inside the first conveyance chamber 631a. The second conveying member 633 is disposed inside the second conveyance chamber 631b. The first and second conveying members 632 and 633 are disposed one above the other along the top-bottom direction. The second conveying member 633 lies close to and extends parallel to the development roller 634. The first and second conveying members 632 and 633 are supported on the developer container 631 so as to be rotatable about axes extending horizontally parallel to the development roller 634.

The first and second conveying members 632 and 633 have basically the same configuration. The first and second conveying members 632 and 633 have a conveying blade formed spirally around the outer circumference of a rotation shaft extending along the longitudinal direction of the developer container 631. The first conveying member 632 conveys, while stirring, developer inside the first conveyance chamber 631a along the axial direction of its rotation from one side to the other side along the longitudinal direction of the developer container 631. The second conveying member 633 conveys, while stirring, developer inside the second conveyance chamber 631b along the axial direction of its rotation from the other side to one side along the longitudinal direction of the developer container 631. That is, the first and second conveying members 632 and 633 convey, while stirring, developer in opposite directions to circulate it in a predetermined circulation direction through the pair of communication portions.

The development roller 634 is located to the side of the second conveying member 633 and is disposed in the opening of the developer container 631, with part of the development roller 634 exposed out of the developer container 631. The development roller 634 is disposed opposite the photosensitive drum 61 and is located close to the photosensitive drum 61. The development roller 634 is supported on the developer container 631 so as to be rotatable about an axis extending parallel to the axis of the photosensitive drum 61.

The development roller 634 carries on its outer circumferential surface the toner to be supplied to the outer circumferential surface of the photosensitive drum 61 in a region opposite the photosensitive drum 61. The development roller 634 carries the toner inside the second conveyance chamber 631b of the developer container 631 and supplies it to the photosensitive drum 61. In other words, the development roller 634 supplies the toner inside the second conveyance chamber 631b to the outer circumferential surface of the photosensitive drum 61 and attaches the toner to the electrostatic latent image to develop it, thereby forming the toner image.

The regulating blade 635 is disposed upstream, in the rotation direction of the development roller 634, of a region where the development roller 634 and the photosensitive drum 61 face each other. The regulating blade 635 is located close to the development roller 634, opposite it, and is disposed with a predetermined interval between the tip end of the regulating blade 635 and the outer circumferential surface of the development roller 634. The regulating blade 635 extends over the entire dimension of the development roller 634 along its axial direction. The regulating blade 635 regulates the layer thickness of the developer carried on the outer circumferential surface of the development roller 634 that passes through the gap between the tip end of the regulating blade 635 and the outer circumferential surface of the development roller 634.

As the first and second conveying members 632 and 633 rotate, the developer inside the developer container 631 circulates between the first and second conveyance chambers 631a and 631b in a predetermined circulation direction through the pair of communication portions. Meanwhile, the toner inside the developer container 631 is stirred and thereby electrostatically charged to be carried on the outer circumferential surface of the development roller 634. The developer carried on the outer circumferential surface of the development roller 634 has its layer thickness regulated by the regulating blade 635 and is then, as the development roller 634 rotates, conveyed to a region where the development roller 634 and the photosensitive drum 61 face each other. When a predetermined development voltage is applied to the development roller 634, under the potential difference from the potential on the surface (outer circumferential surface) of the photosensitive drum 61, the toner in the developer carried on the outer circumferential surface of the development roller 634 moves over to the outer circumferential surface of the photosensitive drum 61 in the region where they face each other. Thus, the electrostatic latent image on the outer circumferential surface of the photosensitive drum 61 is developed with toner into a toner image.

As shown in FIGS. 8 and 9, the rotation shaft 636 and the bearing portion 637 are disposed on outer faces of the developer container 631, specifically counter faces 631f1 and 631f2 opposite the left-right pair of side plates 2s, respectively, of the apparatus body 2. The rotation shaft 636 and the bearing portion 637 are disposed below the region where the development roller 634 and the photosensitive drum 61 face each other.

The rotation shaft 636 extends outward from the counter face 631f1 of the developer container 631 so as to protrude along the axial direction Dx. The rotation shaft 636 is inserted in a hole 2h provided in a side plate 2s of the apparatus body 2 (see FIGS. 4, 5, and 6).

The bearing portion 637 is recessed inward from the counter face 631f2 of the developer container 631 along the axial direction Dx. The bearing portion 637 receives a pivot 2x provided on the side plate 2s of the apparatus body 2 (see FIGS. 4, 5, and 7).

The hole 2h is provided in one of the left-right pair of side plates 2s. The hole 2h penetrates the side plate 2s along the axial direction Dx of the photosensitive drum 61. The pivot 2x is provided on the other of the left-right pair of side plates 2s, that is, the counter face (inner face) facing the developer container 631. The pivot 2x extends into the apparatus body 2, toward the developer container 631, along the axial direction Dx of the photosensitive drum 61.

The rotation axes of the rotation shaft 636 and the bearing portion 637 are disposed coaxially, parallel to the axial direction Dx of the photosensitive drum 61. The developing portion 63 is supported on the left-right pair of side plates 2s via the rotation shaft 636 and the bearing portion 637 so as to be rotatable (swingable) about their rotation axes. The developing portion 63 is movable about the rotation shaft 636 and the bearing portion 637 between a development position, in which the development roller 634 is located close to the photosensitive drum 61, and a retracted position, in which the development roller 634 is located away from the photosensitive drum 61.

The image forming portion 6 includes a pressing portion 65 as shown in FIG. 3. The pressing portion 65 is located adjacent to the developing portion 63, and is disposed above the development roller 634. In other words, with respect to the top-bottom direction, the pressing portion 65 is disposed at the side opposite, across the development roller 634, from a lower part of the developing portion 63 where the rotation shaft 636 and the bearing portion 637 are disposed, hence above the developing portion 63. With respect to the front-rear direction (the rotation direction of the intermediate transfer belt 71), the pressing portion 65 is disposed behind the photosensitive drum 61 across the developing portion 63, hence behind the developing portion 63, and is disposed opposite the developing portion 63 (developer container 631).

The pressing portion 65 includes a compression coil spring 651. Under the urging force of the compression coil spring 651, the pressing portion 65 urges the developing portion 63 toward the photosensitive drum 61 about the rotation shaft 636 and the bearing portion 637.

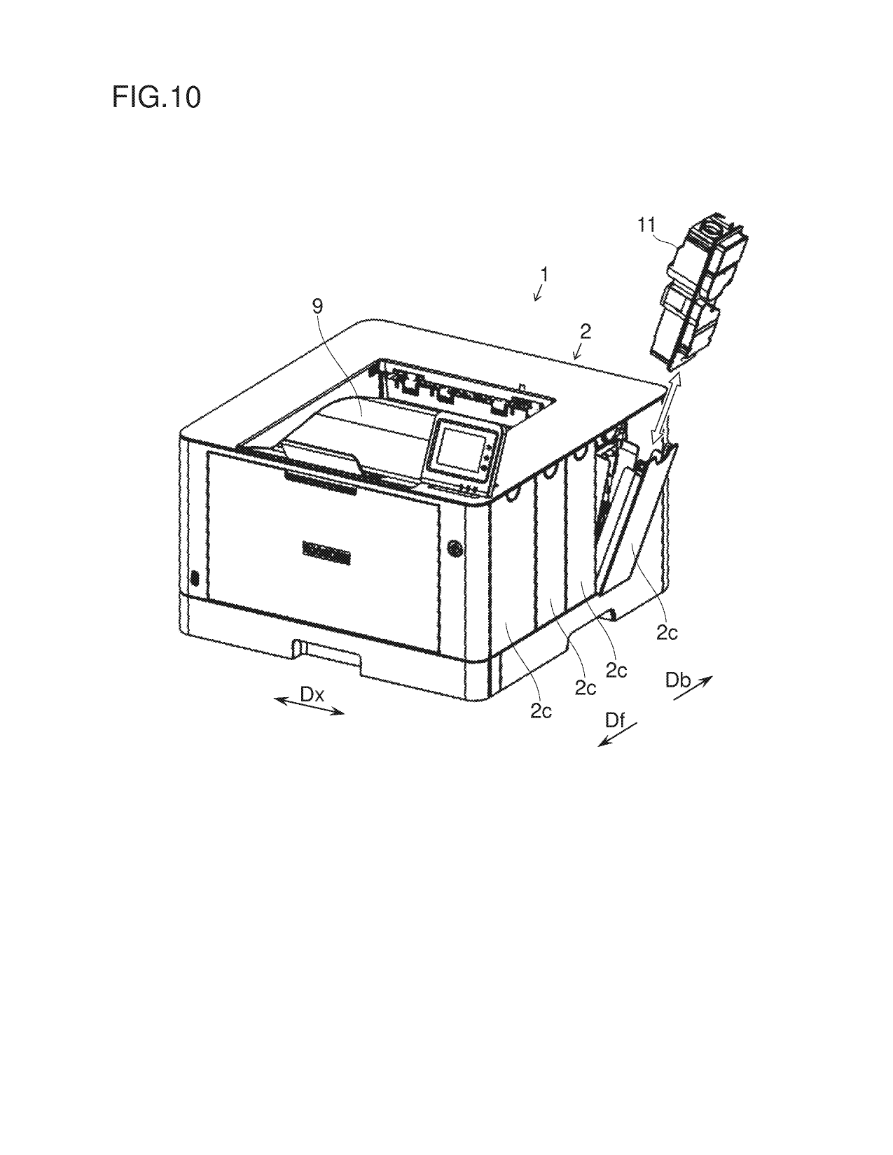

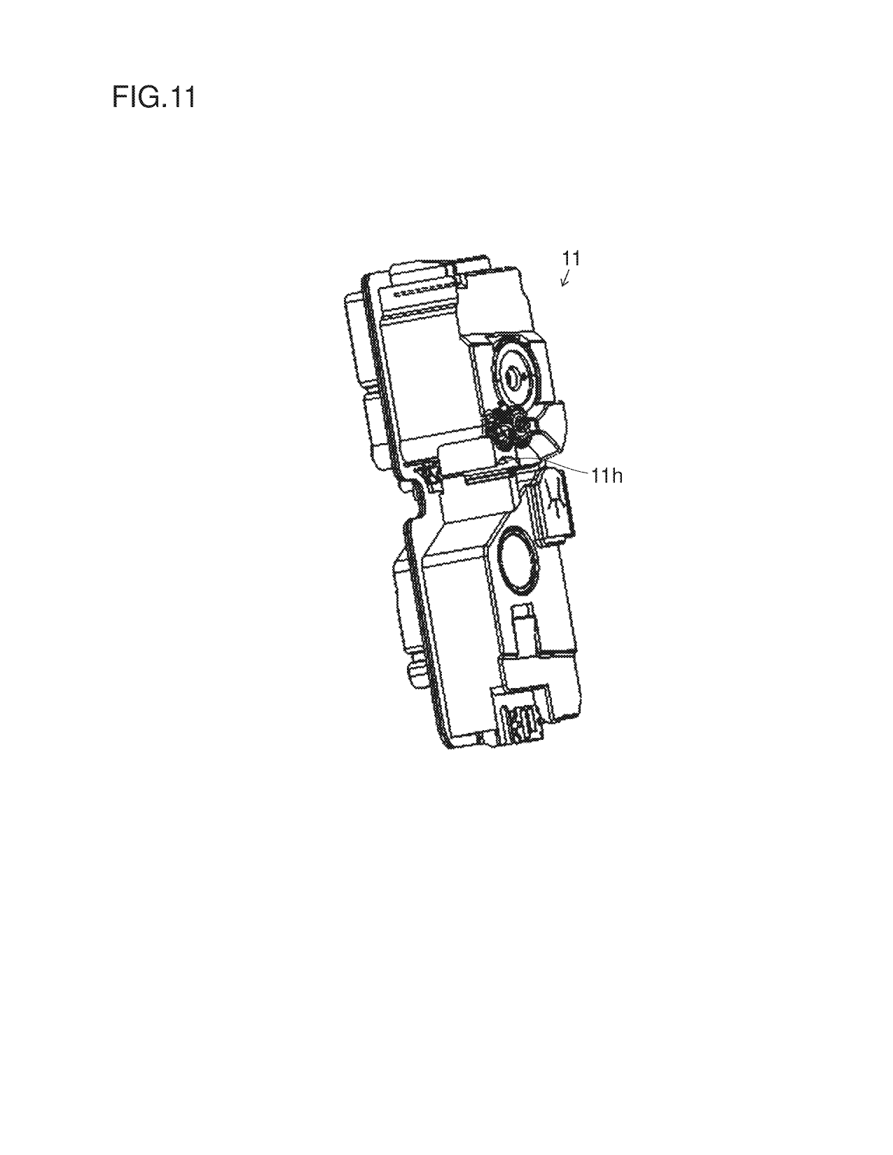

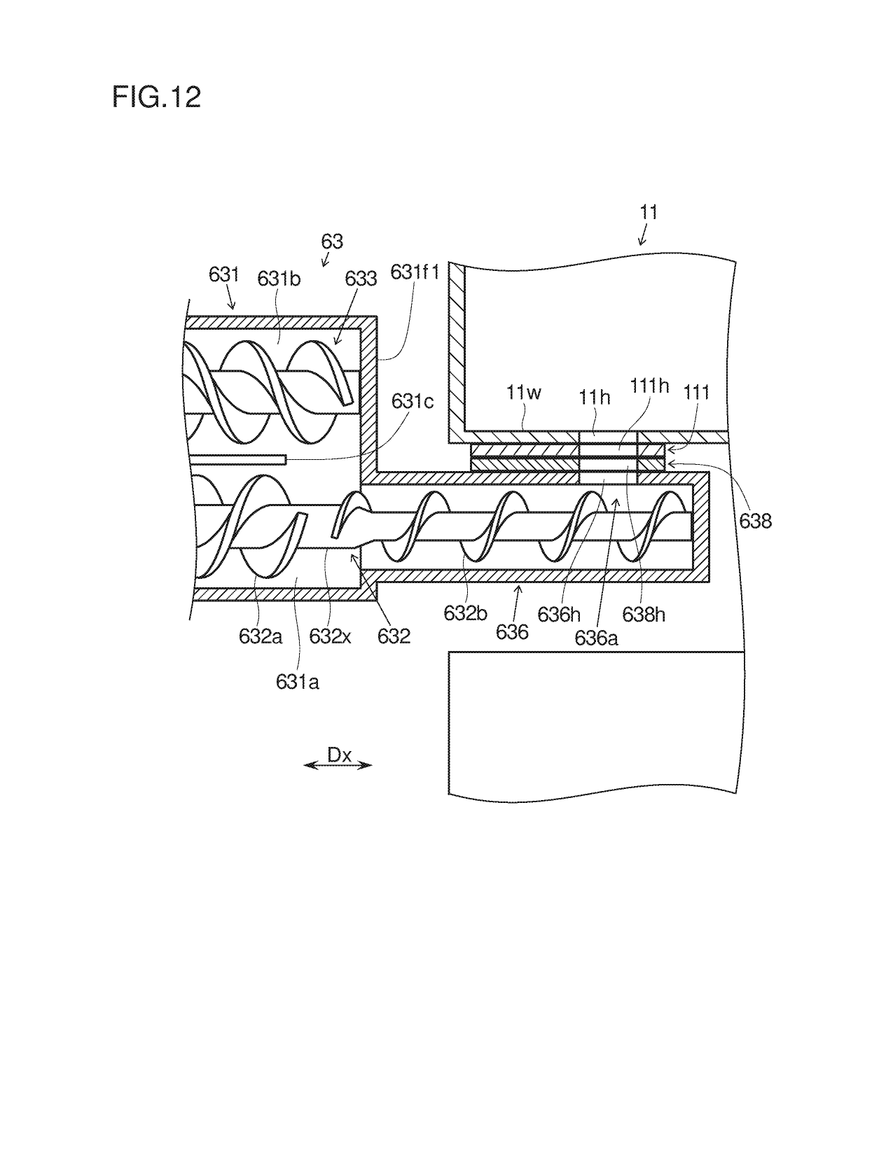

In connection with the supplying of toner to the developing portion 63, the image forming apparatus 1 includes a container 11. FIG. 10 is an exterior perspective view of the image forming apparatus 1 in FIG. 1, showing a state with the cover 2c open and the toner container 11 removed. FIG. 11 is a perspective view of the toner container in FIG. 10. FIG. 12 is a sectional front view of the coupling structure between the developing portion 63 in FIG. 4 and the container 11.

The toner container 11 is provided so as to be removable from the apparatus body 2 of the image forming apparatus 1. Four of the containers 11 are provided to correspond respectively to the four image forming portions 6 (for four colors). As shown in FIG. 10, the container 11 can be mounted in and removed from the apparatus body 2 with a cover 2c, provided in one side face of the apparatus body 2, open. The container 11 stores toner (developer) to be supplied to the developing portion 63.

Four of the covers 2c are provided to correspond respectively to the four containers 11. The four covers 2c are arranged side by side along the front-rear direction of the apparatus body 2, along the direction along which the four image forming portions 6 (see FIG. 2) are arranged. The cover 2c can be opened with an upper part of it tilted outward about an axis at its lower end that extends in the front-rear direction of the apparatus body 2. The container 11 can be put in from over and taken out to over the open cover 2c.

As shown in FIG. 12, the rotation shaft 636 of the developing portion 63 couples to the container 11. The rotation shaft 636 of the developing portion 63 has, in a part of it where it couples to the container 11, a toner inlet portion 636a. The toner inlet portion 636a has a toner inlet port 636h through which the toner (developer) in the container 11 passes into the developing portion 63. The toner inlet port 636h is open in a radial direction in a top end part of the rotation shaft 636, so that the toner (developer) in the container 11 falls from above to pass into the rotation shaft 636.

In the above configuration, in the developing portion 63, the toner inlet portion 636a, through which toner is supplied into the developing portion 63, is provided in the rotation shaft 636 for moving the development roller 634 closer to and away from the photosensitive drum 61. This helps suppress the reaction force involved in the coupling with the apparatus body 2 of the part of the developing portion 63 where it is supplied with toner. It is thus possible to suppress the effect of the inertia moment about the rotation shaft 636 of the developing portion 63 and thus to keep a proper positional relationship between the photosensitive drum 61 and the development roller 634.

As shown in FIG. 12, the rotation shaft 636 of the developing portion 63 is provided further upstream of the upstream end of the first conveyance chamber 631a along the developer conveyance direction. The rotation shaft 636 connects to the first conveyance chamber 631a. The interior of the rotation shaft 636 and the interior of the first conveyance chamber 631a communicates with each other.

The rotation shaft 632x of the first conveying member 632 extends continuously into the rotation shaft 636. One end of the rotation shaft 632x along the axial direction is rotatably supported on the developer container 631 at the upstream end of the rotation shaft 636 with respect to the developer conveyance direction in the first conveyance chamber 631a. That is, the rotation shaft 636 of the developing portion 63 is disposed coaxially with the rotation shaft 632x of the first conveying member 632.

In the above configuration, the inertia moment about the axis of the first conveying member 632 during the operation of the developing portion 63 acts coaxially with the rotation shaft 636 of the developing portion 63. The positional relationship between the photosensitive drum 61 and the development roller 634 is previously set about the rotation shaft 636 of the developing portion 63, and this helps suppress the effect of the inertia moment about the axis of the first conveying member 632. It is thus possible to keep a proper positional relationship between the photosensitive drum 61 and the development roller 634.

The toner inlet port 636h is disposed at the upstream end of the rotation shaft 636 with respect to the developer conveyance direction in the first conveyance chamber 631a. The toner inlet port 636h is open above the rotation shaft 632x of the first conveying member 632. Through the toner inlet port 636h, the toner (developer) in the container 11 passes into the developing portion 63.

The first conveying member 632 includes, in addition to a conveying blade 632a formed inside the first conveyance chamber 631a, an introduction blade 632b. These two blades are provided in the order of the introduction blade 632b and the conveying blade 632a from the toner inlet portion 636a toward the first conveyance chamber 631a. Like the conveying blade 632a, the introduction blade 632b is provided integrally with the rotation shaft 632x and is formed spirally along the axial direction on an outer circumferential part of the rotation shaft 632x.

The introduction blade 632b is formed upstream of the conveying blade 632a with respect to the developer conveyance direction in the first conveyance chamber 631a and is disposed inside the rotation shaft 636 of the developing portion 63. The introduction blade 632b is wound in the same direction as the conveying blade 632a. That is, the developer conveyance direction in the rotation shaft 636 of the developing portion 63 is the same as the developer conveyance direction in the first conveyance chamber 631a. Thus, the introduction blade 632b conveys the developer having passed into the rotation shaft 636 of the developing portion 63 through the toner inlet port 636h in the same direction as does the conveying blade 632a, and supplies the developer into the developer container 631 (first conveyance chamber 631a).

The container 11 has a toner outlet port 11h in a part of it where it couples to the rotation shaft 636 of the developing portion 63. The toner outlet port 11h is located above the rotation shaft 636 in the part coupling to the rotation shaft 636 of the developing portion 63, and is provided in a wall portion 11w that faces, along the top-bottom direction, an upper part of the outer circumferential surface of the rotation shaft 636. The toner outlet port 11h opens downward in the wall portion 11w. Through the toner outlet port 11h, the toner (developer) in the container 11 passes out toward the rotation shaft 636 of the developing portion 63.

With the container 11 mounted in the apparatus body 2 and the developing portion 63 and the container 11 coupled together as shown in FIG. 12, the toner inlet port 636h of the developing portion 63 is arranged to face the toner outlet port 11h and couples to it. Then, through the toner inlet port 636h of the developing portion 63, the toner (developer) in the container 11 passes into the developing portion 63 (rotation shaft 636).

In the above configuration, through the rotation shaft 636 of the developing portion 63 the toner (developer) in the container 11 can be supplied into the developing portion 63. That is, in a configuration designed to keep a proper positional relationship between the photosensitive drum 61 and the development roller 634, toner can be supplied to the developing portion 63 easily.

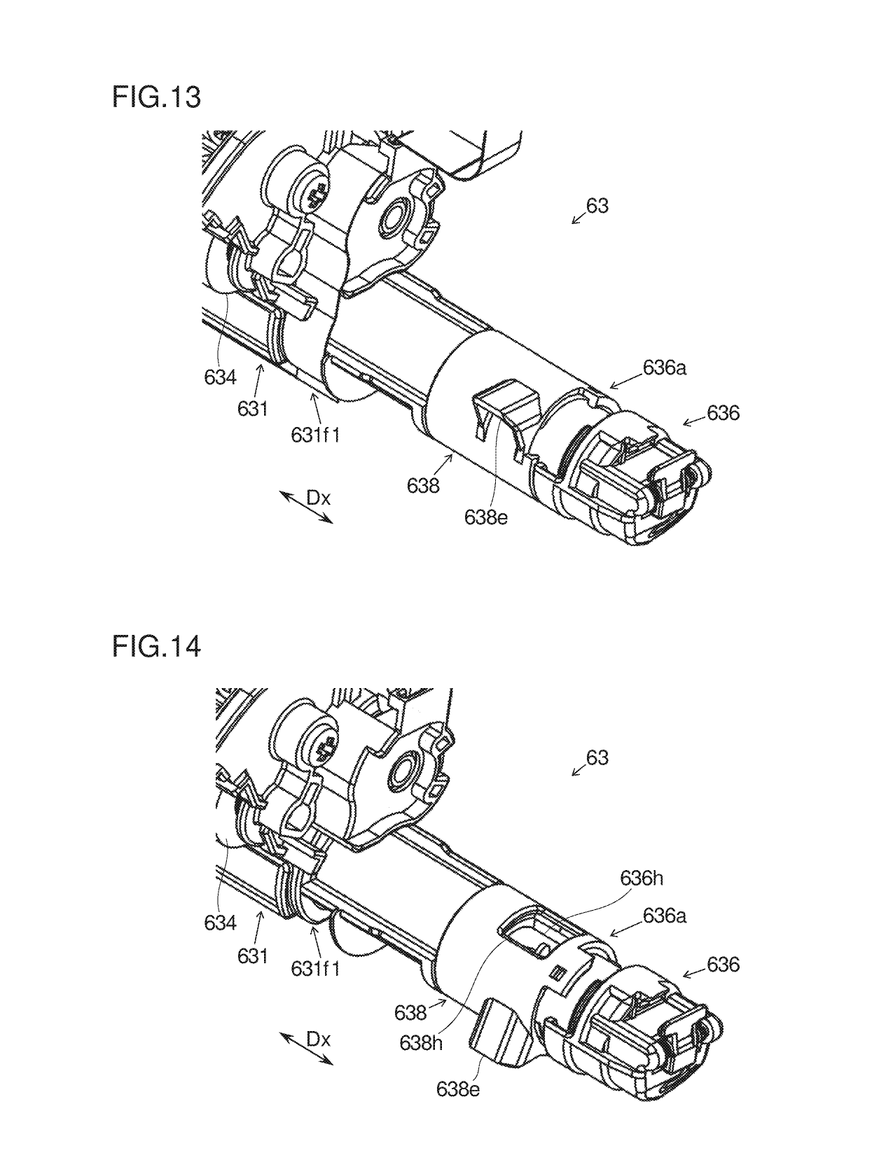

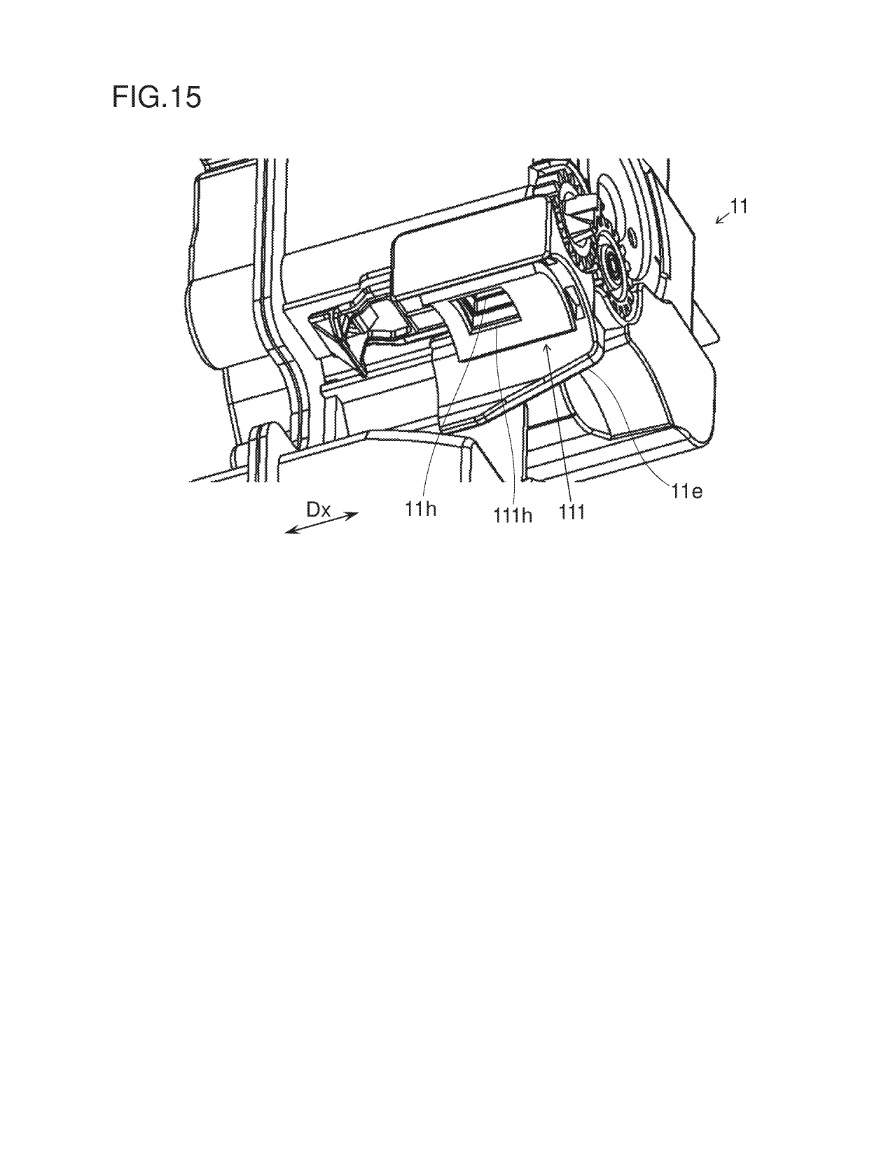

FIG. 13 is a perspective view of a part of the developing portion 63 in FIG. 8 around the rotation shaft 636. FIG. 14 is a perspective view of a part of the developing portion 63 in FIG. 13 around the rotation shaft 636, showing a state with a shutter member 638 open. FIG. 15 is an enlarged perspective part view of a part of the container 11 in FIG. 11 around the toner outlet port 11h.

The container 11 includes a seal member 111. The seal member 111 is configured as, for example, a plate-form or sheet-form elastic member. The seal member 111 is affixed to the bottom face of the wall portion 11w of the container 11, that is, the face facing the rotation shaft 636 of the developing portion 63. The seal member 111 has, below the toner outlet port 11h, a through hole 111h penetrating the seal member 111 along the top-bottom direction. The through hole 111h is formed, for example, in the same shape and size as the toner outlet port 11h, and is configured so as not to prevent the passage of toner through the toner outlet port 11h.

Thus, the seal member 111 is disposed in an outer circumferential part of the toner outlet port 11h. With the container 11 mounted in the apparatus body 2 and the developing portion 63 and the container 11 coupled together as shown in FIG. 12, the seal member 111 makes contact with the outer circumferential part of the toner inlet port 636h of the developing portion 63.

The toner inlet portion 636a of the developing portion 63 includes a shutter member 638. The shutter member 638 is formed in a cylindrical shape extending coaxially with the rotation shaft 636, and is fixed to an outer circumferential part of the rotation shaft 636. The shutter member 638 is fitted so as to be movable around the outer circumferential surface of the rotation shaft 636 in the circumferential direction. The shutter member 638 has a through hole 638h that penetrate it in a radial direction. The through hole 638h is formed, for example, in the same shape and size as the toner inlet port 636h, and is configured so as not to prevent the passage of toner through the toner inlet port 636h.

The shutter member 638 rotationally moves between an open position, in which it leaves open the toner inlet port 636h so that the through hole 638h and the toner inlet port 636h communicate with each other, and a closed position, in which it keeps closed the toner inlet port 636h so that the through hole 638h and the toner inlet port 636h do not communicate with each other. The rotation shaft 636 includes an urging member (not shown) that all the time urges the shutter member 638 toward the closes position of the toner inlet port 636h.

As shown in FIG. 15, the container 11 includes a shutter opening/closing portion 11e. The shutter opening/closing portion 11e is disposed at a position at which the shutter member 638 of the developing portion 63 makes contact with it when the developing portion 63 and the container 11 are coupled together. The shutter member 638 has an engagement segment 638e that makes contact with the shutter opening/closing portion 11e of the container 11. The engagement segment 638e protrudes outward from an outer circumferential part of the shutter member 638.

At its outer circumferential edge, the shutter opening/closing portion 11e of the container 11 makes contact with the engagement segment 638e of the shutter member 638. The outer circumferential edge of the shutter opening/closing portion 11e that makes contact with the shutter member 638 is curved along the circumferential direction as one goes in directions toward and away from the rotation shaft 636 along the axial direction Dx of the rotation shaft 636.

Thus, when the container 11 is mounted in the apparatus body 2, as the container 11 approaches the rotation shaft 636 of the developing portion 63, the shutter opening/closing portion 11e engages with the engagement segment 638e of the shutter member 638 and moves (rotates), against the urging member of the rotation shaft 636, the shutter member 638 from the closed position (see FIG. 13) to the open position (see FIG. 14). On the other hand, when the container 11 is removed from the apparatus body 2, as the container 11 moves away from the rotation shaft 636 of the developing portion 63, the shutter opening/closing portion 11e is disengaged from the engagement segment 638e of the shutter member 638 and, under the urging force of the urging member of the rotation shaft 636, the shutter member 638 moves (rotates) from the open position to the closed position. That is, when the container 11 is mounted in and removed from the apparatus body 2, the shutter member 638 engages with and disengaged from the container 11 to open and close the toner inlet port 636h.

With the above configuration, with respect to the keeping of the positional relationship between the photosensitive drum 61 and the development roller 634, it is possible to suppress the effect of the reaction force associated with the elastic force of the seal member 111 and the reaction force associated with the opening and closing movement of the shutter member 638 at where the developing portion 63 is supplied with toner, that is, at where the rotation shaft 636 and the container 11 are coupled together. It is thus possible to keep a proper positional relationship between the photosensitive drum 61 and the development roller 634.

While an embodiment of the present disclosure has been described above, this is in no way meant to limit the scope of the present disclosure.

For example, while in the above embodiment, the image forming apparatus 1 is assumed to be what is called a tandem-type image forming apparatus for color printing that forms images of a plurality of colors sequentially so as to overlay them on each other, this is not meant as any limitation to such models. The image forming apparatus can be a non-tandem-type image forming apparatus for color printing or an image forming apparatus for monochrome printing.

What is claimed is:

1. An image forming apparatus comprising:
an apparatus body;
an image carrying member on an outer circumferential surface of which an electrostatic latent image is formed;
a developing portion having a developer carrying member that supplies toner to the electrostatic latent image to form a toner image, the developing portion being supported so as to be swingable about a rotation shaft relative to the apparatus body, the developer carrying member being movable about the rotation shaft between a developing position where the developer carrying member is located close to the image carrying member and a retracted position where the developer carrying member is located away from the image carrying member; and
a container removably mounted in the apparatus body, the container storing the toner supplied to the developing portion,
wherein
the rotation shaft of the developing portion has a toner inlet portion through which the toner in the container passes into the developing portion.

2. The image forming apparatus according to claim 1, wherein
the developing portion includes a conveying member that rotates to convey, while stirring, the toner in the developing portion,
wherein
the rotation shaft of the developing portion is disposed coaxially with a rotation shaft of the conveying member.

3. The image forming apparatus according to claim 1, wherein
the container has a toner outlet port through which the toner passes out toward the developing portion,
wherein
the toner inlet portion of the developing portion has a toner inlet port that is disposed opposite and coupled to the toner outlet port of the container and through which the toner in the container passes into the developing portion.

4. The image forming apparatus according to claim 3, wherein
the container has a seal member that is disposed on an outer circumferential part of the toner outlet port and that, when the container is mounted in the apparatus body, makes contact with an outer circumferential part of the toner inlet port of the developing portion,
wherein
the toner inlet portion of the developing portion has a shutter member that, when the container is mounted in and removed from the apparatus body, opens and closes the toner inlet port by engaging with and disengaging from the container.
